(19) United States
(12) Patent Application Publication
(10) Pub. No.: US 2008/0299275 A1
(43) Pub. Date: Dec. 4, 2008

(54) Fruit Infused Vegetable Fat Based Confectionery Product

(76) Inventors: Vladimir Miller, Thornhill (CA); Van Miller, Norval (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/756,896

(22) Filed: Jun. 1, 2007

(51) Int. Cl. A23G 3/40; A23G 1/30; A23L 1/222; A23G 1/32

(52) U.S. Cl. 426/534

(57) ABSTRACT

A vegetable fat based confectionery product for use as a confectionery coating or chip in food products comprises vegetable fat, which may be cocoa butter or fat used in compound chocolate, as a principal fat constituent. There is also included in the fat constituent 0.5% to 3% by weight of anhydrous freeze-dried fruit. Accordingly, the flavor of the included fruit infuses the fat based confectionery product. Typically, the freeze-dried fruit is added to cocoa butter, if used, following a conventional conching process step; but the freeze-dried fruit may be mechanically admixed to the fat constituent. Depending on its melting point, the confectionery coating may be used on health bars or the like, or on frozen ice cream bars.

### FIELD OF THE INVENTION

This invention relates to confectionery products, and particularly to confectionery products that are based on cocoa butter, or other vegetable fats and oils as are used in compound chocolate formulations. The confectionery products of the present invention have freeze-dried fruit included therein. The resulting product may have similar characteristics to those of conventional chocolate or white chocolate, or compound chocolate, in coating or chip form, except that it is infused with the flavor of the freeze-dried fruit or fruits that have been included into the cocoa butter or vegetable fat base. Additional constituents are typically employed as is common with various kinds of chocolate, including compound chocolate, white chocolate, milk chocolate, and the like.

### BACKGROUND OF THE INVENTION

Chocolate has been employed for many years in couverture or coating applications, and more recently in the form of chips or chunks in baking applications. Chocolate chips or chunks may also be found in some novelty ice cream products. It has also been known to flavor or color cocoa butter based edible fat confectionery products, typically by the addition of liquid flavoring additives such as vanilla or caramel, artificial fruit flavors, flavored essential oils, and the like. It has further been known to alter the flavor of confectionery chocolate coatings and the like by the addition of nuts such as almonds or peanuts, or chunks of fruit such as strawberry or pineapple.

Also, compound chocolate is often used in confectionery products, especially those which are dipped or molded. As is well known, compound chocolate derives its chocolate flavor from cocoa, but its fat base is not cocoa butter. Rather, compound chocolate is based on lauric or non-lauric fats, such as palm kernel oil, coconut oil, partially hydrogenated soy, soy/cottonseed or cottonseed/soy oils, and the like, as is well-known to confectioners and chocolate makers. Some of the short chain oils may also have been selectively fractionated, as well. Typically, any of the vegetable oil constituents in compound chocolate for a higher melting point than cocoa butter, and do not need to be tempered.

Therefore, in the present discussion, the term “vegetable fat” is meant to encompass and refer to cocoa butter, and any of the fats and oils which are typically employed in compound chocolate formulations, as discussed above.

In any event, the use of fruit flavored confectionery chocolate coatings or chips, where the fruit flavor is infused into the cocoa butter fat base, or the compound chocolate formulation, of the confectionery chocolate has been hitherto unknown.

The present inventors have quite unexpectedly discovered that if certain freeze-dried fruits are included in the vegetable fat base of a chocolate confectionery product, whether it is white chocolate, sweet chocolate, dark chocolate, milk chocolate, or a lower compound chocolate, then the flavor of the fruit which has been included in the cocoa butter fat base will be prominent in the confectionery product. However, it must be stressed, and will be discussed in greater detail thereafter, that the fruit constituent must have been freeze-dried.

One advantage of freeze-dried fruit is that it is anhydrous, and typically is or can be rendered to have a powder-like consistency. For purposes of present invention, not all fruits are suitable for use as an admixture to edible oil-based table spreads so as to infuse the cocoa butter based confectionery product with fruit flavor. For example, melons of all sorts, apples and pears, avocados, gooseberries, star fruit, and other exotic fruits, are either difficult to freeze dry or have a flavor which is inconsistent with the purposes of the present invention. On the other hand, most berries and currants, and other relatively strongly flavored fruits such as pineapples, or mangoes, peaches, apricots, nectarines, and the like, lend themselves to the purposes of the present invention.

It will be noted that a characteristic of freeze-dried fruit of the sort which will be employed herein is that there is typically a high concentration of the fruit flavor present in the freeze-dried product, so that relatively small amounts of freeze-dried fruit will provide the flavor profile that is required.

Some brief discussion of the process of freeze drying fruit now follows.

First, it should be noted that freeze-dried fruit is fruit from which they water content has been sublimated. In other words, the freezing step is one which is taken place below the eutectic of the fruit which has been freeze-dried, so that it has taken place at a temperature lower than the triple point at which the solid and liquid phases of the fruit can exist. This ensures that sublimation rather than melting will have occurred, so that water soluble sugars and flavor elements of the fruit are not carried away from the fruit in a liquid phase.

Typically, freeze drying of fruit is carried out in two phases; a primary drying phase, and a secondary drying phase. These phases are typically carried out under vacuum, and typically at temperatures below −50° C. The primary drying phase may remove as much is 98% of water in the fruit by sublimation; and the secondary drying phase is utilized two sublimated the remaining approximately 2% of water that has been adsorbed during the primary drying phase. Once the fruit has been freeze-dried, the vacuum is usually broken with an inert gas such as nitrogen, and the freeze-dried fruit product may be packaged or further treated for purposes of the present invention.

For example, if the freeze-dried fruit has large particle size, it may be run through rollers so as to reduce the freeze-dried fruit to a powder. Other processes which are well-known to those skilled in the art may also be employed. Moreover, if fruits such as raspberries or pineapple have been freeze-dried, they may have seeds or fiber chunks which are too large for purposes of present invention. If so, the freeze-dried fruit may be screened so as remove seeds or other particles which are larger than a given size; typically, 1 mm or 3 mm.

It will be understood, therefore, that the mouth sense of the table spread product in keeping with the present invention, as described hereafter, may range from relatively smooth to slightly grainy.

It should also be noted that if the freeze-dried fruit is packaged in hermetic packaging so as to prevent reabsorption moisture, it may be stored at room temperature without refrigeration, and be protected against spoilage for several years. This is because essentially all of water has been removed from the fruit, so as to inhibit the action of microorganisms or enzymes which would normally spoil or degrade the fruit. Moreover, the fruits which are chosen are ones which do not have a liquid constituent which is also capable of sublimation, such as acetic acid or citric acid, or alcohol which might be found in the fruit which has begun to ferment.

Typically, the preparation of cocoa butter based confectionery products in keeping with the present invention follows the same preparation steps as the preparation of conventional chocolate. That is to say, the usual chocolate making steps, particularly after the separation of cocoa liquor from the cocoa butter, and including the conching process, may be employed; and the inclusion of the freeze-dried fruit in the cocoa butter fat base will occur as a further conching step which is usually carried out after the conventional conching and at a lower conching pressure. However, as noted hereafter, in some cases the freeze-dried fruit may be included in the cocoa butter fat base by mechanical admixture therewith.

the preparation of compound chocolate based confectionery products in keeping with the present invention is much simpler, requiring only the admixture of the freeze-dried fruit into the compound chocolate formulation during the preparation thereof.

### DESCRIPTION OF THE PRIOR ART

The present inventors have participated in the preparation of edible fat-based discrete flavoring additives such as those described in U.S. Pat. No. 6,576,287, issued Jun. 10, 2003. That patent, however, is particularly related to the production of anhydrous flavoring additives which are provided in the form of chips, flakes, or chunks, where the edible oil constituent as a melting point of between 20° C. and 40° C., and the flavoring constituent may be such as cinnamon, maple, vanilla, botanical flavors, etc.

The present inventors have also participated in the preparation of a resilient pure chocolate coating composition which may be employed in the manufacture of novelty ice cream bars and the like. That coating is taught in U.S. Pat. No. 6,488,971, issued Dec. 3, 2002. That pure chocolate coating composition is anhydrous, with a melting point above 0° C. and below 20° C. Thus, the resilient pure chocolate coating is less brittle and fragile than conventional chocolate coating compositions which employ vegetable oils as a major constituent.

Also, the present inventors have participated in the provision of chocolate-based fat systems which have improved organoleptic properties, as taught in U.S. Pat. No. 6,641,857, issued November for 2003. This edible anhydrous chocolate-based fat system may be light chocolate, dark chocolate, or white chocolate, and includes an additional sweet flavor which is arrived at by infusing or saturating the granulated sugar component of the fat system with an essential oil of the chosen flavor.

### SUMMARY OF THE INVENTION

In accordance with one aspect of the present invention, there is provided with a vegetable fat based confectionery product which is used as a confectionery coating or chip in food products, and which comprises vegetable fat as a principal fat constituent thereof.

The vegetable fat based confectionery product has included therewith 0.5% to 3% by weight of anhydrous freeze-dried fruit.

By doing so, the vegetable fat based confectionery product is infused with the flavor of the included freeze-dried fruit.

Typically, the fruit is chosen from the group consisting of raspberries, strawberries, blueberries, blackberries, loganberries, lingonberries, cranberries, red currants, black currants, mangoes, pineapples, peaches, apricots, nectarines, and mixtures thereof.

The particle size of the included freeze-dried fruit is generally less than 3 mm; and in some cases it may be less than 1 mm.

In keeping with the present invention, the principal fat constituent will typically emulate the cocoa butter constituent of various types of conventional chocolate. Thus, the principal fat constituent may further comprise sugar and cocoa liquor; and it may also further comprise vanilla.

Likewise, when the principal fat constituent is cocoa butter, it may further comprise sugar, cocoa liquor, milk or milk powder, and vanilla.

Moreover, if it is to emulate the fat constituent of white chocolate, and when the principal fat constituent is cocoa butter, it may further comprise sugar, milk or milk powder, and vanilla.

In general, the principal fat constituent of any cocoa butter based formulation of the confectionery product of the present invention has been conched at an initial conching pressure during preparation thereof, and the freeze-dried fruit constituent has been added to the conched fat constituent during a further conching step at a lower conching pressure than the initial conching pressure.

However, in keeping with another aspect of the present invention, the included freeze-dried fruit constituent may have been mechanically admixed to the principal fat constituent.

A feature of the present invention is that the confectionery product may have a melting point above 40° C., so that it may be used as a confectionery coating for cookies, fruit bars, and health bars; or it may be used as the baking chip or as a chip in a novelty ice cream product.

Another feature the present invention is that the confectionery product may have a melting point below 0° C., so that it may be used as a confectionery coating for frozen ice cream bars and frozen yogurt bars.

Yet another feature the present invention is that the principal fat constituent of the confectionery product may be compound chocolate formulation. Thus, since is the intent to the present invention that the principal fat constituent will, in any event, emulate the cocoa butter constituent of various types of conventional chocolate, the principal fat constituent may further comprise sugar and cocoa liquor; and it may also further comprise vanilla.

Likewise, when the principal fat constituent is compound chocolate formulation, it may further comprise sugar, cocoa liquor, milk or milk powder, and vanilla.

Finally, if the principal fat constituent is to emulate the fat constituent of white chocolate, and when the principal fat constituent is compound chocolate formulation, it may further comprise sugar, milk or milk powder, and vanilla.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

In general, because for the most part the vegetable fat based confectionery product of the present invention is cocoa butter based, it therefore has a principal fat constituent which emulates the principal fat constituent of various types of chocolate—except compound chocolate—and it follows that the manufacture of cocoa butter based confectionery product in keeping with the present invention will utilize conventional chocolate making processes and apparatus. Particularly, the manufacturing process will emulate the manufacturing process of various kinds of chocolate such as light chocolate, dark chocolate, milk chocolate, and white chocolate, by varying the amount of cocoa liquor (if any), sugar, milk or milk powder, and other natural ingredients that may be employed in the manufacture of various kinds of confectioners chocolate. However, after the initial conching process at an initial conching pressure, the conching pressure may be relieved to some extent and the freeze-dried fruit constituent added at that point in time sole it is included in the formulation but at a lower conching pressure.

The freeze-dried fruit may have previously been treated in one manner or in other so as to adjust its consistency to be like a powder, or slightly granular with particle sizes up to 1 mm or up to 3 mm; or the granularity or fineness of the cocoa butter based confectionery product being made may be adjusted by the expedient of adjustment of the conching pressure, as is well-known to those skilled in the chocolate art. Thus, the mouth sense of the cocoa butter based confectionery product will be adjusted to some greater or lesser extent. Indeed, if the cocoa butter based confectionery product is to be manufactured by mechanical admixture of the freeze-dried fruit constituent, then its particle size may be adjusted so as to preclude clogging of mixing nozzles and the like.

It will be noted that come in any event, the cocoa butter based confectionery product in keeping with the present invention is not a eutectic mixture of fat system together with the included freeze-dried fruit constituent.

As noted above, the melting point of the cocoa butter based confectionery product in keeping with the present invention may be adjusted in the manner well known to those skilled in the chocolate art. For example, if the melting point is adjusted so as to be relatively high, say above 40° C., then the confectionery product may be used as a confectionery coating for cookies and cookie bars, fruit bars, health bars, and the like. Moreover, such a confectionery product may also be formed or molded in conventional equipment for further use to as a baking chip or even for use as a chip in a novelty ice cream product.

On the other hand, if the melting point is adjusted so as to be relatively depressed, say below 0° C., then the confectionery product may be used as a confectionery coating for frozen ice cream bars, frozen yogurt bars, and the like.

In all cases, the inclusion of the freeze-dried fruit constituent is such as either to add to the chocolate flavor or, in the case of white chocolate, to provide a noticeable fruit flavor.

However, it must again be stressed that the freeze-dried fruit is such that it has been freeze-dried in a manner whereby the moisture content of the fruit has been sublimated away from the fruit, at a temperature below the triple point or eutectic point of the fruit, whereby an anhydrous product is achieved which has high flavor concentration.

When the principal fat constituent of the confectionery product of the present invention is compound chocolate formulation, then the freeze-dried fruit is admixed thereto at a convenient time during the preparation of the formulation. However, the same precautions and conditions apply to the freeze-dried fruit as discussed above.

It will also be understood from the above discussion that the fat based spreadable table spreads of the present invention are capable of being labeled with such wording as “all natural”, because they contain no chemical preservatives or other additives which would require special labeling consideration. However, when certain partially hydrogenated or fractionated oils are employed in a compound chocolate formulation in keeping with the present invention, then it may be necessary to have such fact noted on the label.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A vegetable fat based confectionery product for use as a confectionery coating or chip in food products, comprising vegetable fat as a principal fat constituent thereof;
wherein said vegetable fat based confectionery product has included therewith 0.5% to 3% by weight of anhydrous freeze-dried fruit;
whereby said vegetable fat based confectionery product is infused with the flavor of the included freeze-dried fruit.

2. The vegetable fat based confectionery product of claim 1, wherein said fruit is chosen from the group consisting of raspberries, strawberries, blueberries, blackberries, loganberries, lingonberries, cranberries, red currants, black currants, mangoes, pineapples, peaches, apricots, nectarines, and mixtures thereof.

3. The vegetable fat based confectionery product of claim 2, wherein the particle size of the included freeze-dried food is less than 3 mm.

4. The vegetable fat based confectionery product of claim 2, wherein the particle size of the included freeze-dried food is less than 1 mm.

5. The vegetable fat based confectionery product of claim 2, wherein said principal fat constituent is cocoa butter, and further comprises sugar and cocoa liquor.

6. The vegetable fat based confectionery product of claim 2, wherein said principal fat constituent is cocoa butter, and further comprises sugar, cocoa liquor, and vanilla.

7. The vegetable fat based confectionery product of claim 2, wherein said principal fat constituent is cocoa butter, and further comprises sugar, cocoa liquor, milk or milk powder, and vanilla.

8. The vegetable fat based confectionery product of claim 2, wherein said principal fat constituent is cocoa butter, and further comprises sugar, milk or milk powder, and vanilla.

9. The vegetable fat based confectionery product of claim 5, wherein said principal fat constituent has been conched at an initial conching pressure during preparation thereof, and said freeze-dried fruit constituent has been added to the conched fat constituent during a further conching step at a lower conching pressure than said initial conching pressure.

10. The vegetable fat based confectionery product of claim 7, wherein said principal fat constituent has been conched at an initial conching pressure during preparation thereof, and said freeze-dried fruit constituent has been added to the conched fat constituent during a further conching step at a lower conching pressure than said initial conching pressure.

11. The vegetable fat based confectionery product of claim 8, wherein said principal fat constituent has been conched at an initial conching pressure during preparation thereof, and said freeze-dried fruit constituent has been added to the conched fat constituent during a further conching step at a lower conching pressure than said initial conching pressure.

12. The vegetable fat based confectionery product of claim 2, wherein said included freeze-dried fruit constituent has been mechanically admixed to said principal fat constituent.

13. The vegetable fat based confectionery product of claim 2, wherein said confectionery product has a melting point above 40° C., and is used as a confectionery coating for cookies, fruit bars, and health bars.

14. The vegetable fat based confectionery product of claim 2, wherein said confectionery product has a melting point above 40° C., and is used as a baking chip or as a chip in a novelty ice cream product.

15. The vegetable fat based confectionery product of claim 2, wherein said confectionery product has a melting point below 0° C., and is used as a confectionery coating for frozen ice cream bars and frozen yogurt bars.

16. The vegetable fat based confectionery product of claim 2, wherein said principal fat constituent is compound chocolate formulation, and further comprises sugar and cocoa liquor.

17. The vegetable fat based confectionery product of claim 2, wherein said principal fat constituent is compound chocolate formulation, and further comprises sugar, cocoa liquor, and vanilla.

18. The vegetable fat based confectionery product of claim 2, wherein said principal fat constituent is compound chocolate formulation, and further comprises sugar, cocoa liquor, milk or milk powder, and vanilla.

19. The vegetable fat based confectionery product of claim 2, wherein said principal fat constituent is compound chocolate formulation, and further comprises sugar, milk or milk powder, and vanilla.
